(19) United States
(12) Patent Application Publication
(10) Pub. No.: US 2022/0294903 A1
(43) Pub. Date: Sep. 15, 2022

(54) VIRTUAL PRIVATE AGENT FOR MACHINE-BASED INTERACTIONS WITH A CONTACT CENTER

(71) Applicant: Avaya Management L.P., Durham, NC (US)

(72) Inventors: Manish Dusad, Galway (IE); Valentine C. Matula, Granville, OH (US); Kazim Hussain, Galway (IE)

(21) Appl. No.: 17/199,598

(22) Filed: Mar. 12, 2021

(51) Int. Cl. H04M 3/51; H04M 3/523

(52) U.S. Cl. CPC H04M 3/5166; H04M 3/5141; H04M 3/5232; H04M 3/5183

(57) ABSTRACT

Contact centers often utilize automated agents to converse with customers of the contact center. As provided herein, a user may utilize a virtual private agent to converse with a contact center. A user device is configured to converse with human and/or automated agents to exchange information on behalf of the user. Tasks may be issued by the user to the user device which, may gather any required additional information, and initiate a call. The call comprising a number of prompts which are then analyzed and respond to in a manner determined to perform the task. If the remote system is discovered to also be automated, the speech-based communications utilized for human agents may be discontinued and non-speech tones utilized for more efficient machine-to-machine communications.

### COPYRIGHT NOTICE

A portion of the disclosure of this patent document contains material that is subject to copyright protection. The copyright owner has not objected to the facsimile reproduction by anyone of the patent document or the patent disclosure as it appears in the Patent and Trademark Office patent files or records, but otherwise reserves all copyright rights whatsoever.

### FIELD OF THE DISCLOSURE

The invention relates generally to systems and methods for communications between nodes on a network and particularly to machine-determined content of the communications.

### BACKGROUND

In today's contact center environments, customers interact with automated systems of the contact centers, such as interactive voice response (IVR) menus, and select options to navigate through the options presented. Once all necessary options are selected, the customer may be presented with hold music as they wait until an agent becomes available to join the call. Certain systems will allow customers to provide a call-back number and, upon an agent becoming available, the contact center dials the customer and connects the call to the agent. Contact centers often utilize other automated agents, such as text chat bots and virtual agents. If a customer has special needs or a disability, they may not be able to interact with contact center agents, whether human or automated, or do so with difficulty.

Automated systems, such as those providing automated agents of a contact center, utilize a machine (e.g., a computing device comprising one or more microprocessors and associated input-output devices and/or network interfaces to other machines) to receive human speech, such as from a customer of a contact center during a voice telephone call, and outputs synthetic human speech, generated by the machine. The generated speech (e.g., phonemes, utterances, and other vocalizations) and/or the content of the speech (e.g., the specific meaning or message conveyed by the speech) that, when presented by an output device (e.g., a speaker of the telephone utilize by the customer) produces human speech understandable to a human as if it were native human speech. Human-machine communications utilizing human speech, may utilize natural language processing (NLP). NPL may be utilized as a means to determine the content of speech and is described by various resources, including Wikipedia.org (https://en.wikipedia.org/wiki/Natural_language_processing), which is incorporated herein by reference for all that it teaches, including all cited references therein, ad infinitum.

### SUMMARY

Agents of a contact center, in particular automated agents (e.g., chat bots, IVR, virtual agents, etc.) are designed to interact with a human user (herein, “user”), such as a customer of an enterprise, including but not limited to a business, government agency, and educational institution, etc., (herein, “contact center”). The contact center makes and/or receives electronic communications to and/or from users over a network. Often the user is presented with a recorded or generated speech, such as a voice prompt, and responds to the prompt with their own speech and/or dual-tone multi-frequency signaling (DTMF). Chat bots provide an alternative interface, such as typing text response to prompt, and automated agents provide the ability to speak utilizing a subset of preprogrammed words or natural language, such as to explain a problem with the virtual agent determining the underlying issue and the appropriate resource (human or automated) necessary to address the issue.

Despite the benefits, such automated agents are on the contact center side of a call. As a general introduction, and in one embodiment, a virtual private agent is provided that supports a user and interacts with the contact center, whether the interaction is with a human, an automated agent, or a combination thereof. The user may know what is desired, or at least acceptable, from a call with a contact center but may or may not be aware of the means such information will be conveyed. For example, the call may be answered by a human agent who can be presented with the task and respond according, the agent may ask for specific information, the agent may be an automated agent requiring a selection of a particular option, the user may be placed on hold, etc. As a result, the user needs to be engaged with the call and respond to prompts as they are received.

These and other needs are addressed by the various embodiments and configurations of the present invention. The present invention can provide a number of advantages depending on the particular configuration. These and other advantages will be apparent from the disclosure of the invention(s) contained herein.

A virtual private agent may have, or a have access to, any necessary information prior or during a call with a contact center in order to complete a task. The virtual private agent receives prompts from the contact center and responds to the prompts to best complete the task, and engage with the agent (human and/or automated) to accomplish the task. An in-call exception or post-call indication of success or failure to complete the task may be provided back to the user and/or other systems.

In one embodiment, methods and systems are described that provide a personalized virtual private agent per user. The virtual private agent interacts with a contact center to perform the desired transaction with the contact center agent. The contact center agent may be a human or automated agent providing content, including prompts to answer questions or select options, in a format and/or order that may be unknown to the virtual private agent until presented with each specific instance of a question or prompt to provide information and utilizing any real-time communication type (e.g., voice, interactive text chat, etc.).

In another embodiment, the virtual private agent may initiate an audio communication (e.g., voice, DTMF, etc.) with a contact center, but subsequently determine that the interaction is with an automated contact center agent, or vice versa, and communicate in machine-friendly tones/human-unfriendly tones. In other words, a user known to be embodied as a virtual private agent to a contact center and a contact center known to the virtual private agent to be automated, may communicate in a format much faster and compact than that which is enabled by normal human speech, such as to utilize tones and tone patterns to symbolically represent message elements.

The virtual private agent is variously embodied and may comprise an application, installation on a device, and/or settings to enable the virtual private agent to be specific to a user or a set of users (e.g., family, work team, etc.). Such a personalized private agent may be installed as a stand-alone application, such on a telephony device (public switched telephone network, cellular network, voice over internet protocol, etc.), website or cloud-based application, and/or other computing platform comprising a network interface to a network, which is referred to herein as a “local system” solely as a means to distinguish from the “remote system” comprising a contact center.

A user may instruct a private virtual agent to perform a particular task requiring an interaction with a remote system via communication over a network with an agent (human, automated, or a combination thereof). The interaction comprising a data exchange wherein the task comprises providing the remote system with at least a datum by the private virtual agent, the private virtual agent receives at least a datum from the remote system, or a combination thereof. Once instructed, the private virtual agent will perform the task (or portions thereof requiring interactions with the contact center) and optionally report back to the user with indica of success or and optionally what caused or is needed to resolve the failure. The task may be performed to completion (e.g., “Make a dinner reservation for the family at 6:30 a week from Friday.”) or partially (e.g., “Get me an agent at Alpha Airlines so I can purchase the tickets on my itinerary.”) wherein the private virtual agent navigates the necessary IVR options, provides relevant information (e.g., purpose of the call, frequent flyer number, itinerary number, etc.), waits on hold and, upon being connected to a human agent, notifies the user to join the call. Such as when the private virtual agent is configured to engage the user to provide secure information (e.g., credit card information) in order to complete the purchase, at which point the private virtual agent may disconnect from the call or optionally resume the call to complete any further steps.

In another embodiment, the user may have a disability that makes interacting with many contact centers difficult or impossible, such as hearing or speech impairments. The virtual private agent may act autonomously to complete a task and/or as a translator to convert text to speech, or vice versa, or speech to sign language, or vice versa, in order to allow the user to interact with the contact center agent.

When calling a contact center, a human user often reaches a machine, namely an automated agent that completes some or all of a task. In another embodiment, a machine, namely the virtual private agent, and/or contact center's automated agent may determine that the communication is only being conducted between machine-based agents and dispense with the slower, speech-based communications. For example, standardized information may be requested by an automated contact center agent. When a user is known to be a human (or at least not known to be automated) the user may be prompted with speech to provide responses to individual content (e.g., “tell me your family name and spell it please,” “tell me your given name and spell it please,” etc.), whereas machine-to-machine information may be provided based on a single prompt, such as to provide all details of a user's name, address, etc., in response to the contact center prompting, such as for, “all mailing address information”. Additionally or alternatively, standardized forms or data blocks may be requested (e.g., “Send address block now.” “Send all data compliant with ‘form 123’ now.” etc.).

In a further option, voice communications may be omitted or discontinued in exchange for modulated-demodulated (modem) audio signals. Machine-to-machine based communications may be performed in (machine generated/recognized) spoken form, tones (e.g., baud tones, DTMF, etc.), or a combination thereof that may be gibberish to an unaided human listener and unreproducible by an unaided human speaking. For example, a communication may be entirely voice-based between a user and the user's virtual private agent and a contact center's automated agent and, upon the conclusion of the task for which the communication is established, a machine-only communication (e.g., tones) may be resend, in a machine-friendly (i.e., human incomprehensible) form that summarizes, supplements, and/or provides duplicate information from that which was provided during the voice portion. For example, it may not be necessary to ensure precision with respect to certain content discussed during a speech-based portion of the communication, when clarified utilizing non-speech machine-friendly format. For example, the virtual private agent may converse with an automated agent utilizing speech, which may include speech content, such as, “my name is Tom Johnson.” and then follow-up with more accurate machine-generated and readable encoded data blocks, such as to symbolically convey “FirstName=‘Thomas’”, LastName=‘Johnsen’”. Accordingly, misunderstandings (e.g., whether the last name was spelled with an “o” or an “e”, or additional information first name is actually “Thomas,” etc. may be conveyed in machine-understandable tones without requiring the time and resource to prompt the user and receive a response.

In one embodiment, a local system is disclosed, comprising: a network interface to a network; a processor comprising machine-readable instructions maintained in a non-transitory memory that when read by the processor, cause the processor to perform: receiving a task from a user wherein completion of the task requires a data exchange with a remote system via the network; engaging in a communication with the remote system; and performing the data exchange within the communication; and wherein the data exchange comprises receiving a prompt from the remote system and providing a response to the prompt determined by the local system and wherein both the prompt and the response comprise speech.

In another embodiment, a method performed by a local system is disclosed, comprising: receiving a task from a user wherein completion of the task requires a data exchange with a remote system via a network; engaging in a communication with the remote system; and performing the data exchange within the communication; and wherein the data exchange comprises receiving a prompt from the remote system and providing a response to prompt determined by the local system and wherein both the prompt and the response comprise speech.

In another embodiment, a local system is described comprising: means to receive a task from a user wherein completion of the task requires a data exchange with a remote system via a network; means to engage in a communication with the remote system; means to perform the data exchange within the communication, wherein the means to perform the data exchange comprises means to receive a prompt from the remote system and provide a response to prompt determined by the local system and wherein both the prompt and the response comprise speech; means to determine whether the remote system is an automated system; and means to, upon determining that the remote system is automated, signal the remote system with indicia of the local system being automated; and means to perform the data exchange comprising non-speech audio tones.

A system on a chip (SoC) including any one or more of the above embodiments or aspects of the embodiments described herein.

One or more means for performing any one or more of the above embodiments or aspects of the embodiments described herein.

Any aspect in combination with any one or more other aspects.

Any one or more of the features disclosed herein.

Any one or more of the features as substantially disclosed herein.

Any one or more of the features as substantially disclosed herein in combination with any one or more other features as substantially disclosed herein.

Any one of the aspects/features/embodiments in combination with any one or more other aspects/features/embodiments.

Use of any one or more of the aspects or features as disclosed herein.

Any of the above embodiments or aspects, wherein the data storage comprises a non-transitory storage device comprise at least one of: an on-chip memory within the processor, a register of the processor, an on-board memory co-located on a processing board with the processor, a memory accessible to the processor via a bus, a magnetic media, an optical media, a solid-state media, an input-output buffer, a memory of an input-output component in communication with the processor, a network communication buffer, and a networked component in communication with the processor via a network interface.

It is to be appreciated that any feature described herein can be claimed in combination with any other feature(s) as described herein, regardless of whether the features come from the same described embodiment.

The term “contact center” is variously embodied and may comprise large corporate contact centers which may be capable of communicating with a large number of customers (e.g., users) simultaneously (e.g., a major airline's reservation system, technical support center of a large manufacturer of electronics, etc.) via a large pool of automated and/or human agents, down to and including a single individual (e.g., a receptionist at a doctor's office, a host at a restaurant, etc.) or single automated agent (e.g., after-hours answering machine/service of a mechanic). Embodiments explicitly provided herein may expand or narrow the use of “contact center” to those embodiments explicitly described with respect to a particular embodiment. Absent any explicit modification, features described with respect to any one embodiment, will comprise a further optional embodiment of any other embodiment described herein, except when such further option(s) is expressly disclaimed or when such further option(s) would result in an impossibility.

The phrases “at least one,” “one or more,” “or,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B, and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an embodiment that is entirely hardware, an embodiment that is entirely software (including firmware, resident software, micro-code, etc.) or an embodiment combining software and hardware aspects that may all generally be referred to herein as a “circuit,” “module,” or “system.” Any combination of one or more computer-readable medium(s) may be utilized. The computer-readable medium may be a computer-readable signal medium or a computer-readable storage medium.

A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible, non-transitory medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device. Program code embodied on a computer-readable medium may be transmitted using any appropriate medium, including, but not limited to, wireless, wireline, optical fiber cable, RF, etc., or any suitable combination of the foregoing.

The terms “determine,” “calculate,” “compute,” and variations thereof, as used herein, are used interchangeably, and include any type of methodology, process, mathematical operation, or technique.

The term “means” as used herein shall be given its broadest possible interpretation in accordance with 35 U.S.C., Section 112(f) and/or Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

The preceding is a simplified summary of the invention to provide an understanding of some aspects of the invention. This summary is neither an extensive nor exhaustive overview of the invention and its various embodiments. It is intended neither to identify key or critical elements of the invention nor to delineate the scope of the invention but to present selected concepts of the invention in a simplified form as an introduction to the more detailed description presented below. As will be appreciated, other embodiments of the invention are possible utilizing, alone or in combination, one or more of the features set forth above or described in detail below. Also, while the disclosure is presented in terms of exemplary embodiments, it should be appreciated that an individual aspect of the disclosure can be separately claimed.

### BRIEF DESCRIPTION OF THE DRAWINGS

The present disclosure is described in conjunction with the appended figures:

FIG. 1 depicts a first system in accordance with embodiments of the present disclosure;

FIG. 2 depicts a first interaction in accordance with embodiments of the present disclosure;

FIG. 3 depicts a second interaction in accordance with embodiments of the present disclosure;

FIG. 4 depicts a first process in accordance with embodiments of the present disclosure;

FIG. 5 depicts a second process in accordance with embodiments of the present disclosure; and

FIG. 6 depicts a second system in accordance with embodiments of the present disclosure.

### DETAILED DESCRIPTION

The ensuing description provides embodiments only and is not intended to limit the scope, applicability, or configuration of the claims. Rather, the ensuing description will provide those skilled in the art with an enabling description for implementing the embodiments. It will be understood that various changes may be made in the function and arrangement of elements without departing from the spirit and scope of the appended claims.

Any reference in the description comprising a numeric reference number, without an alphabetic sub-reference identifier when a sub-reference identifier exists in the figures, when used in the plural, is a reference to any two or more elements with a like reference number. When such a reference is made in the singular form, but without identification of the sub-reference identifier, is a reference one of the like numbered elements, but without limitation as to the particular one of the elements. Any explicit usage herein to the contrary or providing further qualification or identification shall take precedence.

The exemplary systems and methods of this disclosure will also be described in relation to analysis software, modules, and associated analysis hardware. However, to avoid unnecessarily obscuring the present disclosure, the following description omits well-known structures, components, and devices, which may be omitted from or shown in a simplified form in the figures or otherwise summarized.

For purposes of explanation, numerous details are set forth in order to provide a thorough understanding of the present disclosure. It should be appreciated, however, that the present disclosure may be practiced in a variety of ways beyond the specific details set forth herein.

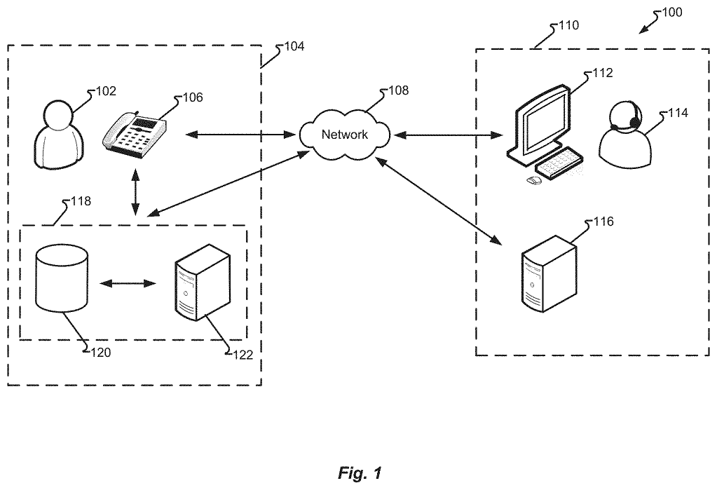

FIG. 1 depicts system 100 in accordance with embodiments of the present disclosure. In one embodiment, local system 104 comprises user device 106 utilized by user 102. While user device 106 may be illustrated as a telephone, it should be appreciated that other communication devices form factors may be utilized, such as a computer, cellular telephone, laptop, etc., which comprise at least one processor and a network interface to network 108. User device 106 comprises a user interface, which may be embodied as a keyboard, mouse, touchpad, touchscreen, microphone, and/or other input device. Additional, user device 106 comprises at least one output device, such as a speaker, display screen, LED or other status-indicating lights, buzzer, haptic feedback, and/or other output device. As a further option, user device 106 may utilize one or more peripheral input/output devices in communication with user device 106.

In one embodiment, user 102 issues a task to user device 106. The task is provided via an input device of user device 106, such as a microphone to receive speech provided by user 102. The speech is received and processed, such as by one or more processors of (or available to) user device 106 to execute an NLP application to determine the task from the speech.

In one embodiment, user device 106 is a stand-alone device that has embodied therein input-output components, processors, memory and/or other data storage, and a network interface to network 108. In other embodiments, user device 106 may utilize other components, such as secondary system 118, which may comprises data storage 120 and/or server 122. Secondary system 118 may offload data processing tasks from the processor(s) of user device 106 or provide additional or alternative services. For example, data storage 120 may maintain a calendar, address book, and/or other data utilized by user 102 and/or other applications for user 102. Server 122 may be embodied as a device providing additional or other services, for example, server 122 may be a smart phone executing a server and/or client for mail, contacts, and/or other information. Additionally or alternatively, data storage 120 and/or server 122 may comprise a third-party service, such as to provide data services (e.g., news, weather, traffic, sports, financial, reference information, etc.). As a result, user 102 asking user device 106, “what is the weather tomorrow,” may cause user device 106 to communicate with server 122 to obtain weather information. In one embodiment, secondary system 118 or a portion thereof may be located remotely and communicate with user device 106 via network 108 and/or another network. It should be appreciated that other topologies may be implemented without departing from the scope of the embodiments herein.

User 102 may request user device 106 to perform a task requiring a data exchange with a different system, such as remote system 110. For example, user device 106 may be capable of machine-based communications or operations that may be determined by user device 106 itself, such as to access an internal clock in response to being asked, “what time is it?”, or to issue a data packet to server 122 of an external system and receive a reply therefrom, such as to obtain the weather.

Contact centers often utilize agents to assist in performing a transaction or otherwise performing a task that generally, but not always, requires more back-and-forth. For example, remote system 110 may comprise agent device 112 utilized by agent 114 operating as a contact center. A back-and-forth may be necessary to complete a particular transaction, such as when user-specific information is necessary. As defined herein, a contact center is variously embodied and may comprise thousands of human agents (e.g., agent 114) each utilizing a corresponding communication device (e.g., agent device 112) and/or automated agents (e.g., automated agent 116), engaged in real-time and/or non-real time communications with customers. A contact center may also be embodied as a smaller (e.g., fewer agent 114 and/or automated agent 116) enterprise, which may comprise a single agent, such as automated agent 116 when embodied as an answering machine or call director, or a single agent 114 as a receptionist or proprietor of a business, who may personally answer calls to a telephone (e.g., agent device 112 when embodied as a telephone or similar communication device). At least one device comprising local system 104 communicates with at least one device comprising remote system 110 via network 108.

In another embodiment, user device 106 executes instructions to provide a virtual private agent. The virtual private agent may utilize a microphone, or other input device, and a speaker, or other output device, to interact with user 102 and further comprise a network interface to establish a communication with remote system 110 and exchange data therebetween. User device 106 may present the virtual private agent as a human analog that is capable of understanding speech provided by user 102 and generating speech to reply to user 102. Additionally, user device 106 may be operational to communicate utilizing speech when speech is the form of communication utilized by remote system 110. For example, a telephone call to remote system 110 may be connected to agent device 112, which may be embodied as a computer, telephone, etc., and operated by agent 114, such as to hear speech provided by the caller and provide speech thereto. Similarly, a call to remote system 110 may be connected to an automated agent, such as automated agent 116 which similarly receives human inputs in the form of speech and/or tones which may be triggered by a human (e.g., dual-tone modulated frequency (DTMF)) utilizing a telephone or similar device providing speech to and from the caller. In other embodiments, a call may be initiated by agent 114 and/or automated agent 116 and answered by a callee, such as by user device 106.

Remote system 110 is configured to communicate via encoded audio signals over network 108, the audio signals comprising speech. Accordingly, a call placed to, or initiated by, remote system 110 may be configured to communicate utilizing sound only, specifically human speech and optionally DTMF tones. As will be described below with respect to certain, but not all, embodiments, the sound may comprise machine-understandable non-speech tones at a subsequent point in a data exchange between local system 104 and remote system 110 that was initiated utilizing speech.

User device 106 may establish a communication comprising audio with remote system 110 and conduct an exchange of data solely, or partially, utilizing speech. For example, user 102 may provide a task to user device 106, such as, “Make dinner reservations for Friday evening.” User device 106 may access rules, such as stored in a data storage within user device 106 and/or data storage 120, as well as utilize any subsequence sources of rules, which may further include accessing rules from server 122. Accordingly, user device 106 may have all information necessary to initiate the communication or, optionally, clarify certain points with user 102 (e.g., “Which restaurant?” “For how many people?” “For what time?” etc.), which cannot be ascertained from secondary system 118 or information/instructions maintained internally to user device 106. For example, “I see you have a tentative reservation for 7:00 on your calendar for six people. Is this information I should use to make the reservation?” User 102 either confirms the information is correct or provides the necessary corrections, which may further comprise selecting a restaurant, a number of candidate restaurants, a block of time for which the reservation may be made, and/or other aspect of the task. User device 106 then calls to make the reservation. It should be appreciated that the call may be initiated and user 102 asked by user device 106 to provide any unknown information, for example, “The restaurant is booked for a private event and only has patio seating available, is that acceptable?” With the answer provided, user device 106 continues to interact with remote system 110.

In one embodiment, agent device 112 is connected to the call which is then greeted by agent 114. User device 106, utilizing generated speech, exchanges data with agent 114 to perform the task. Assuming no mandatory condition is violated, the task is completed and the communication terminated. User device 106 may then announce the result to user 102 and/or data storage 120/server 122, such as to say, “You now have a reservation for your party of six at Main Street Bistro for 6:45. 7 o'clock was not available, you are advised not to be late.” Additionally or alternatively, a calendar entry and/or notification to other parties may be provided, such as to update a calendar entry maintained in data storage 120 and/or send a message to server 122 embodied as a mail/message server operable to communicate with the other parties.

In another embodiment, user device 106 may establish a communication comprising audio with remote system 110 and conduct an exchange of data solely, or partially, utilizing speech. For example, the task issued by user 102 to user device 106 may be answered by automated agent 116. Automated agent 116 may interact with callers (e.g., user device 106) during the entirety of the communication or during a portion of the communication, of which a different portion may comprise a human agent, such as agent 114. However, remote system 110, in particular automated agent 116, operates with the assumption that the other node in the communication is operated by a human speaking or optionally pressing keypad keys to trigger DTMF tones. Machine-based communication, such as non-speech tones and non-DTMF tones, may be utilized but only after the communication has first been conducted utilizing speech. In yet another embodiment, communications between local system 104 and remote system 110 is solely limited to speech and excludes all other content that could not be created by nor understood by a human with ordinary abilities.

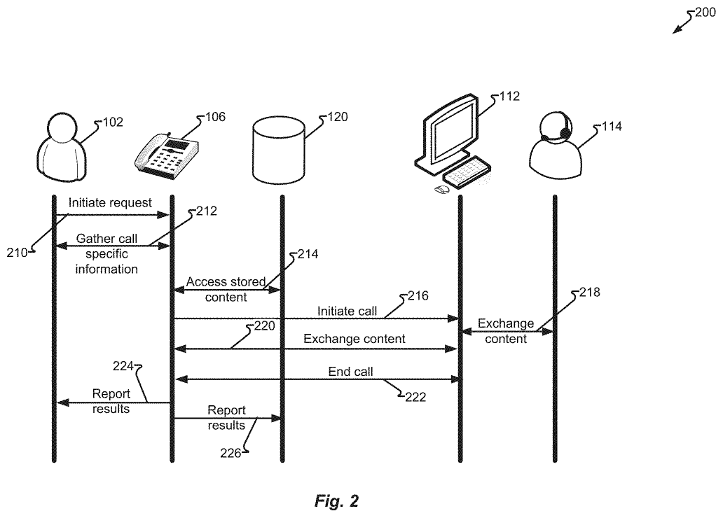

FIG. 2 depicts interaction 200 in accordance with embodiments of the present disclosure. In one embodiment, user 102 creates message 210 to comprise a task to be performed (at least in part) by local system 104, such as to user device 106. User device 106 may send and/or receive message 212 to gather any other information necessary, resolve ambiguities, determine options or limits for options, etc. User device 106 may send/receive message 214 with data storage 120 to gather stored content, such as to access information maintained in a calendar, address book, or other resource, which may optionally be operable to communicate in machine-only formats and medium.

User device 106 then creates event 216 to initiate a call with agent device 112. Agent 114 exchanges messages 218 with agent device 112 and, in turn, messages 220 are exchanged between user device 106 and agent device 112, until termination 222. User device 106 may provide a reporting message 224 to user 102 and/or reporting message/information update message 226 to data storage 120 and/or server 122 (see FIG. 1).

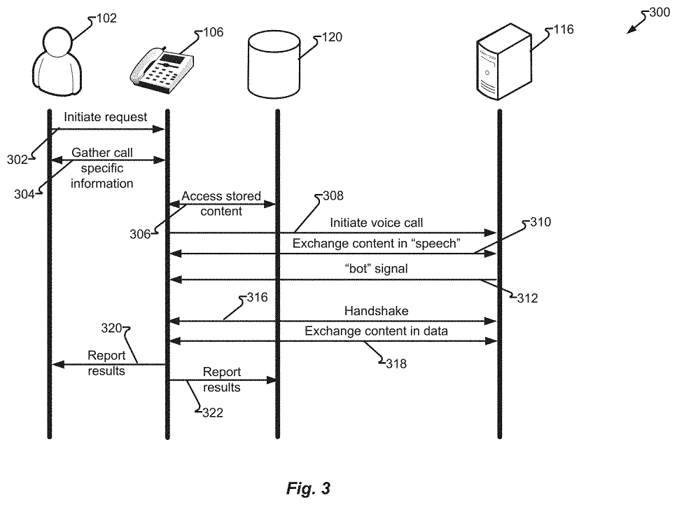

FIG. 3 depicts interaction 300 in accordance with embodiments of the present disclosure. Embodiments herein enable a virtual private agent to conduct a speech-based communication with remote system 110 utilizing speech generated and received by local system 104. The communication between local system 104 and remote system 110 may be initiated with remote system 110 operating under the (incorrect) presumption that local system 104 is a human. Similarly, local system 104 may operate under a similar presumption that remote system 110 is a human, or at least with the assumption that remote system 110 is configured for human communications (e.g., speech). However, local system 104 and remote system 110 may each discover that the other is an automated system, such as described with respect to interaction 300.

Upon determining that each of local system 104 and remote system 110 is automated, communications therebetween may transition to include non-speech audio tones and speech-based communications may be discontinued or supplemented with the non-speech audio tones or vice versa. In one embodiment, the non-speech audio tones are DTMF tones, in other embodiments other modulated/demodulated (modem) tones are utilized which may comprise one or more of state changes, frequency of the state changes, sound frequency(s), and/or combinations thereof that, entirely or in part, is outside the ability of ordinary and unaided human creation and/or comprehension.

In one embodiment, interaction 300 beings with user 102 sending message 302 to comprise a task to be performed, at least in part, by local system 104, such as to user device 106. User device 106 may then send and/or receive message 304 to gather any other information necessary, resolve ambiguities, determine options or limits for options, etc. User device 106 may exchange messages 306 with data storage 120, such as to gather stored content, such as to access information maintained in a calendar, address book, or other resource, which may optionally be operable to communicate in machine-only formats and medium.

User device 106 initiates call 308 with remote system 110 and automated agent 116. Automated agent 116 and user device 106 may exchange messages 310 utilizing speech. However, automated agent 116 may send signal 312 indicating automated agent 116 is automated or otherwise indicate that user device 106 is not engaged in a communication with a remote system 110 comprising a human. In one embodiment, local system 104 may be unsolicited, such as to announce to user device 106 that automated agent 116 is automated. For example, messages 310 may comprise an explicit message in speech (e.g., “This is an automated, if you are a remote agent, signal with . . . ”), encoded “burst” signal within the speech, use of a key word or key phrase, and/or via message that excludes speech (e.g., tone(s), carrier frequency change, etc.) or other audio content that is known to user device 106 to indicate that remote system 110 is automated. In another embodiment, user device 106 may similarly provide a signal to automated agent 116 to indicate that user device 106 is automated. Whether unsolicited or in response to a signal provided by user device 106, signal 312 is received.

If necessary, handshake 316 may be performed to negotiate one or more parameters of non-speech communications, such as baud rate, protocol, message format, etc. Data exchange 318 is then conducted between user device 106 and automated agent 116 utilizing non-speech audio encoded for transmission during the communication. In another embodiment, handshake 316 may comprise address information, channel information, and/or other communication which may be utilized to establish a non-audio-based communication. Data exchange 318 may comprise prompts to respond to data, such as encoded tones in non-speech audio to convey a request for “first name” and wait for a reply from user device 106 similarly encoded in non-speech audio. Additionally or alternatively, more compact communications may be initiated, such as when data exchange 318 provides a prompt, in non-speech audio, to “reply with form 112233” or “reply with the form located at www.website.com\form112233, wherein user device 106 formats a data block compliant with the requested format (e.g., “form 112233”) and responds with the data block as a data exchange 318. As a benefit, although the call is only established to maintain audio communications (analog and/or digitized audio packets), without requiring establishing of a data channel, user device 106 and automated agent 116 may communicate in, faster and more accurate, non-speech audio. Upon termination, user device 106 may report 320 to user 102 and/or report 322 to data storage 120.

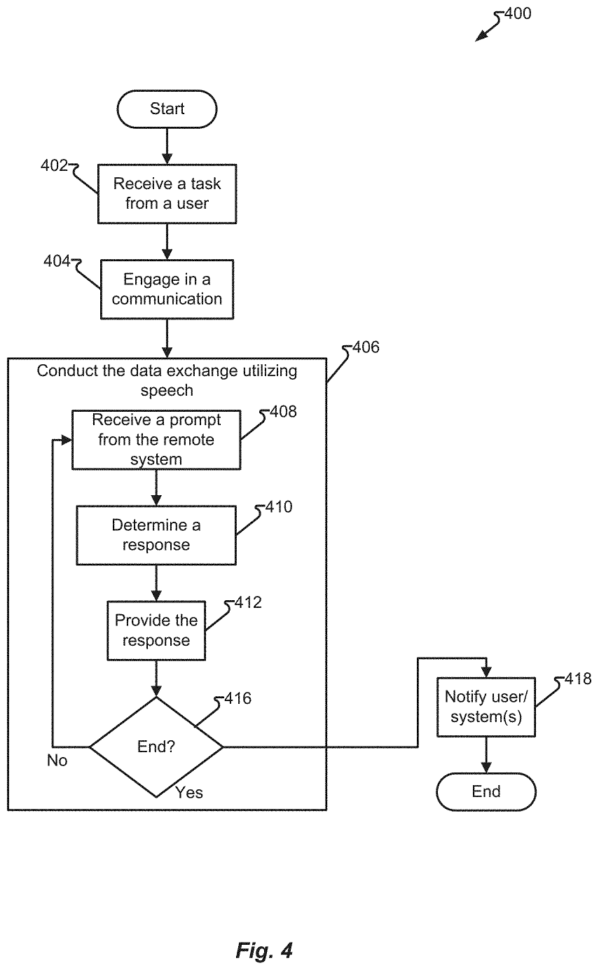

FIG. 4 depicts process 400 in accordance with embodiments of the present disclosure. Process 400 may be embodied as machine-readable instructions maintained in a non-transitory memory that, when read by a processor such as a processor of user device 106, cause the processor to perform the steps of process 400. Process 400 begins at step 402 wherein a task is received by a user, such as user 102. Tasks are variously embodied and may include tasks to be initiated upon issuance of the task, for example, “make dinner reservations,” conditional, “if it is raining tomorrow morning, cancel my tennis lesson,” or ongoing, “answer all incoming calls,” or “if anyone calls that is a ‘service provider’ in my contacts list, process the call on my behalf.”

Next, step 404 engages in a communication, such as between user device 106 and remote system 110 or a portion thereof (e.g., agent device 112 and agent 114 or automated agent 116). The communication comprising speech encoded for transmission via network 108. Step 406 then conducts a data exchange within the communication comprising one or more prompts and responses to the prompts. More specifically, a prompt may be received in step 408, which may comprise a portion of the data exchange, the prompt soliciting a response from user device 106. The prompt may be variously embodied and comprise any one or more of a simple greeting (e.g., “Hello?” “How can I help you?” etc.), a more complex greeting (e.g., “For sales, press ‘1’, to schedule a service call, press ‘2’, . . . ”, “How can I direct your call?” etc.), a request for a datum (e.g., “what is your first name?”), a request for data (“What is your mailing address?”), etc. A response is determined by user device 106, alone or with benefit of secondary system 118 in step 410. The response maybe selected in accordance with the task provided in step 402. For example, the task of step 402 may be to, “Have a service technician service the refrigerator.” In response, step 404 may clarify the make of refrigerator, any days or times to request or decline, etc., and, in response to receiving a prompt in step 408 that says, “Acme refrigeration, how can I help you?” determine a response 410, such as by using NLP, and/or other rules, such as, “I need to schedule a service call for a refrigerator.” The response is then provided, such as by generated speech, in step 412. Test 416 determines if the call has ended and, if determined in the negative loops back to step 408, such as to receive another instance of a prompt in step 408, such as, “The first available time I have is tomorrow afternoon at 4:30,” which may be determined to be an implicit response to accept or deny the appointment offered or, the prompt in step 408 may be more explicit, such as, “The first available time I have is tomorrow afternoon at 4:30. Will that work for you?” Accordingly, a loop comprising step 408, 410, 412, and test 416 may continue until test 416 determines the call is at an end. It should be appreciated that step 408 may simply be a request to perform an action, such as “hold” to wait for an agent or “call back during our regular business hours,” wherein a null response is determined in step 410, with respect to providing a portion of the data exchanged, and step 412 omitted.

Upon test 416 being determined in the affirmative, step 418 may be implemented to report to the user and/or other systems. The report to the user (e.g., user 102) may be conditional, such as in response to user 102 asking, “what did you do today” or “did you make the service appointment for the refrigerator?” or offered automatically. Step 418 may modify other systems (e.g., secondary system 118) such as to update records, send messages, etc. As a further embodiment, any exception for which user device 106 is not able to understand a prompt or determine a response, may cause process 400 to terminate by immediately jumping to step 418 to notify the user and/or other systems of the anomaly.

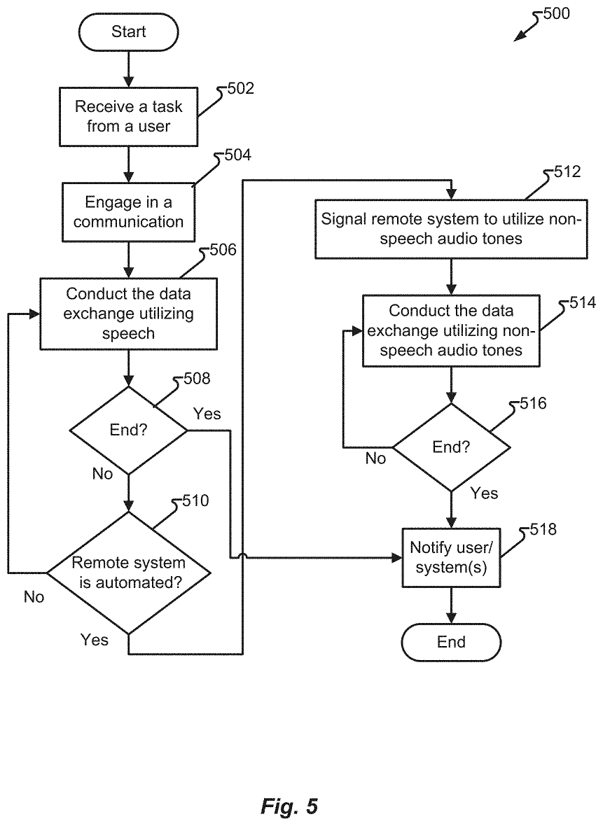

FIG. 5 depicts process 500 in accordance with embodiments of the present disclosure. Process 500 may be embodied as machine-readable instructions maintained in a non-transitory memory that, when read by a processor such as a processor of user device 106, cause the processor to perform the steps of process 500. Process 500 begins by receiving a task in step 502 and engage in a communication with remote system 110, in step 504, which may comprise the same or substantially similar operations of steps 402 and 404 of FIG. 4.

Step 506 conducts the data exchange comprising speech. In an optional embodiment, non-speech audio may be provided that is limited to devices associated with user device 106, namely, DTMF tones. In another embodiment, the communication comprises only speech and is devoid of non-speech audio. Step 506, which may be embodied as a series of prompts and responses, such as described with respect to steps 408, 410, and 412 of FIG. 4. If the communication has concluded, test 508 is determined in the affirmative and process 500 continues at step 518. If test 508 is determined in the negative, test 510 may determine if remote system 110 is automated. Test 508 may occur at any point during the communication. Test 510 may discover a signaling tone (e.g., carrier frequency change, “blip” or burst communication, etc.), speech (e.g., “I am an automated agent.”), or otherwise indicate that remote system 110 is automated in a manner previously determined to be recognized by user device 106 as being automated. Additionally or alternatively, the signal may be in response to an indication provided by user device 106 designed to solicit from remote system 110 an indication of being automated, which may similarity comprise tones and/or other content previously determined to solicit a response indicating automation. If test 510 is determined in the negative, processing continues to step 506. If test 510 is determined in the affirmative, processing continues to step 512.

Step 512 provides a signal to cause remote system 110 to engage in non-speech audio. Step 512 may comprise a handshake or other data exchange, such as to negotiate the particular format, protocol, or other aspect of the non-speech audio. Step 514 then conducts the data exchange between user device 106 and remote system 110 utilizing non-speech audio, until the communication has completed, and test 516 is determined in the affirmative. Otherwise, test 516 loops back to step 514 to continue the data exchange.

Step 514 may comprise non-speech audio to enable user device 106 and remote system 110, or more specifically automated agent 116, to communicate at a speed beyond human capabilities, such as by providing a number of encoded state changes of tone send at a rate (e.g., baud) supported by network 108. Step 514 may concatenate and/or abstract a plurality of prompts such as, in machine-friendly language, such as string of individual prompts presented as a data block, for example “refrigerator make-model-serial_number-date_of_purchase” and/or abstracted, such as “complete form 112233.” At the conclusion step 518 may report to user 102 and/or secondary system 118.

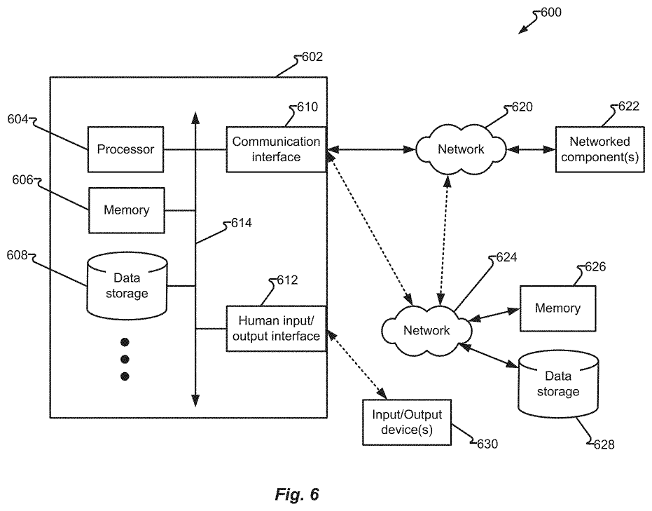

FIG. 6 depicts device user device 106 in system 600 in accordance with embodiments of the present disclosure. In one embodiment, user device 106 may be embodied, in whole or in part, as device 602 comprising various components and connections to other components and/or systems. The components are variously embodied and may comprise processor 604. The term “processor,” as used herein, refers exclusively to electronic hardware components comprising electrical circuitry with connections (e.g., pin-outs) to convey encoded electrical signals to and from the electrical circuitry. Processor 604 may be further embodied as a single electronic microprocessor or multiprocessor device (e.g., multicore) having electrical circuitry therein which may further comprise a control unit(s), input/output unit(s), arithmetic logic unit(s), register(s), primary memory, and/or other components that access information (e.g., data, instructions, etc.), such as received via bus 614, executes instructions, and outputs data, again such as via bus 614. In other embodiments, processor 604 may comprise a shared processing device that may be utilized by other processes and/or process owners, such as in a processing array within a system (e.g., blade, multi-processor board, etc.) or distributed processing system (e.g., “cloud”, farm, etc.). It should be appreciated that processor 604 is a non-transitory computing device (e.g., electronic machine comprising circuitry and connections to communicate with other components and devices). Processor 604 may operate a virtual processor, such as to process machine instructions not native to the processor (e.g., translate the VAX operating system and VAX machine instruction code set into Intel® 9xx chipset code to allow VAX-specific applications to execute on a virtual VAX processor), however, as those of ordinary skill understand, such virtual processors are applications executed by hardware, more specifically, the underlying electrical circuitry and other hardware of the processor (e.g., processor 604). Processor 604 may be executed by virtual processors, such as when applications (i.e., Pod) are orchestrated by Kubernetes. Virtual processors allow an application to be presented with what appears to be a static and/or dedicated processor executing the instructions of the application, while underlying non-virtual processor(s) are executing the instructions and may be dynamic and/or split among a number of processors.

In addition to the components of processor 604, device 602 may utilize memory 606 and/or data storage 608 for the storage of accessible data, such as instructions, values, etc. Communication interface 610 facilitates communication with components, such as processor 604 via bus 614 with components not accessible via bus 614. Communication interface 610 may be embodied as a network port, card, cable, or other configured hardware device. Additionally or alternatively, human input/output interface 612 connects to one or more interface components to receive and/or present information (e.g., instructions, data, values, etc.) to and/or from a human and/or electronic device. Examples of input/output devices 630 that may be connected to input/output interface include, but are not limited to, keyboard, mouse, trackball, printers, displays, sensor, switch, relay, speaker, microphone, still and/or video camera, etc. In another embodiment, communication interface 610 may comprise, or be comprised by, human input/output interface 612. Communication interface 610 may be configured to communicate directly with a networked component or utilize one or more networks, such as network 620 and/or network 624.

Network 108 may be embodied, in whole or in part, as network 620. Network 620 may be a wired network (e.g., Ethernet), wireless (e.g., WiFi, Bluetooth, cellular, etc.) network, or combination thereof and enable device 602 to communicate with networked component(s) 622. In other embodiments, network 620 may be embodied, in whole or in part, as a telephony network (e.g., public switched telephone network (PSTN), private branch exchange (PBX), cellular telephony network, etc.)

Additionally or alternatively, one or more other networks may be utilized. For example, network 624 may represent a second network, which may facilitate communication with components utilized by device 602. For example, network 624 may be an internal network to a business entity or other organization, whereby components are trusted (or at least more so) that networked components 622, which may be connected to network 620 comprising a public network (e.g., Internet) that may not be as trusted.

Components attached to network 624 may include memory 626, data storage 628, input/output device(s) 630, and/or other components that may be accessible to processor 604. For example, memory 626 and/or data storage 628 may supplement or supplant memory 606 and/or data storage 608 entirely or for a particular task or purpose. For example, memory 626 and/or data storage 628 may be an external data repository (e.g., server farm, array, “cloud,” etc.) and allow device 602, and/or other devices, to access data thereon. Similarly, input/output device(s) 630 may be accessed by processor 604 via human input/output interface 612 and/or via communication interface 610 either directly, via network 624, via network 620 alone (not shown), or via networks 624 and 620. Each of memory 606, data storage 608, memory 626, data storage 628 comprise a non-transitory data storage comprising a data storage device.

It should be appreciated that computer readable data may be sent, received, stored, processed, and presented by a variety of components. It should also be appreciated that components illustrated may control other components, whether illustrated herein or otherwise. For example, one input/output device 630 may be a router, switch, port, or other communication component such that a particular output of processor 604 enables (or disables) input/output device 630, which may be associated with network 620 and/or network 624, to allow (or disallow) communications between two or more nodes on network 620 and/or network 624. For example, a connection between one particular user, using a particular user device 106, may be enabled (or disabled) with a particular networked component 622. One of ordinary skill in the art will appreciate that other communication equipment may be utilized, in addition or as an alternative, to those described herein without departing from the scope of the embodiments.

In the foregoing description, for the purposes of illustration, methods were described in a particular order. It should be appreciated that in alternate embodiments, the methods may be performed in a different order than that described without departing from the scope of the embodiments. It should also be appreciated that the methods described above may be performed as algorithms executed by hardware components (e.g., circuitry) purpose-built to carry out one or more algorithms or portions thereof described herein. In another embodiment, the hardware component may comprise a general-purpose microprocessor (e.g., CPU, GPU) that is first converted to a special-purpose microprocessor. The special-purpose microprocessor then having had loaded therein encoded signals causing the, now special-purpose, microprocessor to maintain machine-readable instructions to enable the microprocessor to read and execute the machine-readable set of instructions derived from the algorithms and/or other instructions described herein. The machine-readable instructions utilized to execute the algorithm(s), or portions thereof, are not unlimited but utilize a finite set of instructions known to the microprocessor. The machine-readable instructions may be encoded in the microprocessor as signals or values in signal-producing components and included, in one or more embodiments, voltages in memory circuits, configuration of switching circuits, and/or by selective use of particular logic gate circuits. Additionally or alternative, the machine-readable instructions may be accessible to the microprocessor and encoded in a media or device as magnetic fields, voltage values, charge values, reflective/non-reflective portions, and/or physical indicia.

In another embodiment, the microprocessor further comprises one or more of a single microprocessor, a multi-core processor, a plurality of microprocessors, a distributed processing system (e.g., array(s), blade(s), server farm(s), “cloud”, multi-purpose processor array(s), cluster(s), etc.) and/or may be co-located with a microprocessor performing other processing operations. Any one or more microprocessor may be integrated into a single processing appliance (e.g., computer, server, blade, etc.) or located entirely or in part in a discrete component connected via a communications link (e.g., bus, network, backplane, etc. or a plurality thereof).

Examples of general-purpose microprocessors may comprise, a central processing unit (CPU) with data values encoded in an instruction register (or other circuitry maintaining instructions) or data values comprising memory locations, which in turn comprise values utilized as instructions. The memory locations may further comprise a memory location that is external to the CPU. Such CPU-external components may be embodied as one or more of a field-programmable gate array (FPGA), read-only memory (ROM), programmable read-only memory (PROM), erasable programmable read-only memory (EPROM), random access memory (RAM), bus-accessible storage, network-accessible storage, etc.

These machine-executable instructions may be stored on one or more machine-readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

In another embodiment, a microprocessor may be a system or collection of processing hardware components, such as a microprocessor on a client device and a microprocessor on a server, a collection of devices with their respective microprocessor, or a shared or remote processing service (e.g., “cloud” based microprocessor). A system of microprocessors may comprise task-specific allocation of processing tasks and/or shared or distributed processing tasks. In yet another embodiment, a microprocessor may execute software to provide the services to emulate a different microprocessor or microprocessors. As a result, first microprocessor, comprised of a first set of hardware components, may virtually provide the services of a second microprocessor whereby the hardware associated with the first microprocessor may operate using an instruction set associated with the second microprocessor.

While machine-executable instructions may be stored and executed locally to a particular machine (e.g., personal computer, mobile computing device, laptop, etc.), it should be appreciated that the storage of data and/or instructions and/or the execution of at least a portion of the instructions may be provided via connectivity to a remote data storage and/or processing device or collection of devices, commonly known as “the cloud,” but may include a public, private, dedicated, shared and/or other service bureau, computing service, and/or “server farm.”

Examples of the microprocessors as described herein may include, but are not limited to, at least one of Qualcomm® Snapdragon® 800 and 801, Qualcomm® Snapdragon® 610 and 615 with 4G LTE Integration and 64-bit computing, Apple® A7 microprocessor with 64-bit architecture, Apple® M7 motion comicroprocessors, Samsung@ Exynos® series, the Intel® Core™ family of microprocessors, the Intel® Xeon® family of microprocessors, the Intel® Atom™ family of microprocessors, the Intel Itanium® family of microprocessors, Intel® Core® i5-4670K and i7-4770K 22 nm Haswell, Intel® Core® i5-3570K 22 nm Ivy Bridge, the AMD® FX™ family of microprocessors, AMD® FX-4300, FX-6300, and FX-8350 32 nm Vishera, AMD® Kaveri microprocessors, Texas Instruments® Jacinto C6000™ automotive infotainment microprocessors, Texas Instruments® OMAP™ automotive-grade mobile microprocessors, ARM® Cortex™-M microprocessors, ARM® Cortex-A and ARM926EJ-S™ microprocessors, other industry-equivalent microprocessors, and may perform computational functions using any known or future-developed standard, instruction set, libraries, and/or architecture.

Any of the steps, functions, and operations discussed herein can be performed continuously and automatically.

The exemplary systems and methods of this invention have been described in relation to communications systems and components and methods for monitoring, enhancing, and embellishing communications and messages. However, to avoid unnecessarily obscuring the present invention, the preceding description omits a number of known structures and devices. This omission is not to be construed as a limitation of the scope of the claimed invention. Specific details are set forth to provide an understanding of the present invention. It should, however, be appreciated that the present invention may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components or portions thereof (e.g., microprocessors, memory/storage, interfaces, etc.) of the system can be combined into one or more devices, such as a server, servers, computer, computing device, terminal, “cloud” or other distributed processing, or collocated on a particular node of a distributed network, such as an analog and/or digital telecommunications network, a packet-switched network, or a circuit-switched network. In another embodiment, the components may be physical or logically distributed across a plurality of components (e.g., a microprocessor may comprise a first microprocessor on one component and a second microprocessor on another component, each performing a portion of a shared task and/or an allocated task). It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the invention.

A number of variations and modifications of the invention can be used. It would be possible to provide for some features of the invention without providing others.

In yet another embodiment, the systems and methods of this invention can be implemented in conjunction with a special purpose computer, a programmed microprocessor or microcontroller and peripheral integrated circuit element(s), an ASIC or other integrated circuit, a digital signal microprocessor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this invention. Exemplary hardware that can be used for the present invention includes computers, handheld devices, telephones (e.g., cellular, Internet enabled, digital, analog, hybrids, and others), and other hardware known in the art. Some of these devices include microprocessors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein as provided by one or more processing components.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this invention is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this invention can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Embodiments herein comprising software are executed, or stored for subsequent execution, by one or more microprocessors and are executed as executable code. The executable code being selected to execute instructions that comprise the particular embodiment. The instructions executed being a constrained set of instructions selected from the discrete set of native instructions understood by the microprocessor and, prior to execution, committed to microprocessor-accessible memory. In another embodiment, human-readable “source code” software, prior to execution by the one or more microprocessors, is first converted to system software to comprise a platform (e.g., computer, microprocessor, database, etc.) specific set of instructions selected from the platform's native instruction set.

Although the present invention describes components and functions implemented in the embodiments with reference to particular standards and protocols, the invention is not limited to such standards and protocols. Other similar standards and protocols not mentioned herein are in existence and are considered to be included in the present invention. Moreover, the standards and protocols mentioned herein, and other similar standards and protocols not mentioned herein are periodically superseded by faster or more effective equivalents having essentially the same functions. Such replacement standards and protocols having the same functions are considered equivalents included in the present invention.

The present invention, in various embodiments, configurations, and aspects, includes components, methods, processes, systems and/or apparatus substantially as depicted and described herein, including various embodiments, subcombinations, and subsets thereof. Those of skill in the art will understand how to make and use the present invention after understanding the present disclosure. The present invention, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease, and\or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments, configurations, or aspects for the purpose of streamlining the disclosure. The features of the embodiments, configurations, or aspects of the invention may be combined in alternate embodiments, configurations, or aspects other than those discussed above. This method of disclosure is not to be interpreted as reflecting an intention that the claimed invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the invention.

Moreover, though the description of the invention has included description of one or more embodiments, configurations, or aspects and certain variations and modifications, other variations, combinations, and modifications are within the scope of the invention, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

What is claimed is:

1. A local system, comprising:
a network interface to a network;
a processor comprising machine-readable instructions maintained in a non-transitory memory that when read by the processor, cause the processor to perform:
receiving a task from a user wherein completion of the task requires a data exchange with a remote system via the network;
engaging in a communication with the remote system;
performing the data exchange within the communication; and
wherein the data exchange comprises receiving a prompt from the remote system and providing a response to the prompt determined by the local system and wherein both the prompt and the response comprise speech.

2. The local system of claim 1, wherein the instructions further cause the processor to perform:
parsing the prompt to determine therefrom a set of candidate responses that satisfy the prompt;
determining one of the set of candidate responses most closely associated with satisfying the task; and
wherein providing the response comprises providing the one of the set of candidate response.

3. The local system of claim 1, wherein at least one of the prompt or the response comprise speech wherein the content of the at least one of the prompt or the response is conveyed in speech and devoid of non-speech sound.

4. The local system of claim 1, wherein the instructions further cause the processor to perform:
determining whether the remote system is an automated system; and
upon determining that the remote system is automated, signaling the remote system with indicia of the local system being automated.

5. The local system of claim 4, wherein the instructions cause the processor to perform determining whether the remote system is automated, further comprising instructions to cause the processor to determine whether an encoded signal is received from the remote system, wherein the encoded signal is previously determined to indicate that the remote system is automated.

6. The local system of claim 4, wherein the instructions cause the processor to perform determining whether the remote system is automated, further comprising sending to the remote system an encoded signal previously determined to indicate that the local system is automated and, in response receiving a reply signal previously determined to indicate that the remote system is automated.

7. The local system of claim 4, wherein the instructions further cause the processor to perform, upon determining the remote system is automated, perform the data exchange comprising non-speech audio tones.

8. The local system of claim 7, wherein the prompt comprises a first portion of the non-speech audio tones which further comprises an encoded prompt for the response to comprise a plurality of discrete content.

9. The local system of claim 8, wherein the instructions further cause the processor to provide the response to comprising a second portion of the non-speech audio tones encoded with the plurality of discrete content.

10. The local system of claim 1, wherein the communication is initiated by the remote system.

11. A method performed by a local system, comprising:
receiving a task from a user wherein completion of the task requires a data exchange with a remote system via a network;
engaging in a communication with the remote system;
performing the data exchange within the communication; and
wherein the data exchange comprises receiving a prompt from the remote system and providing a response to prompt determined by the local system and wherein both the prompt and the response comprise speech.

12. The method of claim 11, further comprising:
parsing the prompt to determine therefrom a set of candidate responses that satisfy the prompt;
determining one of the set of candidate responses most closely associated with satisfying the task; and
wherein providing the response comprises providing the one of the set of candidate response.

13. The method of claim 11, wherein at least one of the prompt or the response comprises speech and is devoid of non-speech sound.

14. The method of claim 11, further comprising:
determining whether the remote system is an automated system; and
upon determining that the remote system is automated, signaling the remote system with indicia of the local system being automated.

15. The method of claim 14, wherein determining whether the remote system is automated, further comprising determining whether an encoded signal is received from the remote system, wherein the remote system provides the encoded signal previously determined to indicate that the remote system is automated.

16. The method of claim 14, wherein determining whether the remote system is automated, further comprising sending to the remote system an encoded signal previously determined to indicate that the local system is automated and, in response receiving a reply signal previously determined to indicate that the remote system is automated.

17. The method of claim 14, wherein the instructions further cause the processor to perform, upon determining the remote system is automated, perform the data exchange comprising non-speech audio tones.

18. The method of claim 17, wherein the prompt comprises a first portion of the non-speech audio tones which further comprises an encoded prompt for the response to comprise a plurality of discrete content.

19. The method of claim 18, further comprising providing the response to comprise a second portion of the non-speech audio tones encoded with the plurality of discrete content.

20. A local system, comprising:
means to receive a task from a user wherein completion of the task requires a data exchange with a remote system via a network;
means to engage in a communication with the remote system;
means to perform the data exchange within the communication, wherein the means to perform the data exchange comprises means to receive a prompt from the remote system and provide a response to prompt determined by the local system and wherein both the prompt and the response comprise speech;
means to determine whether the remote system is an automated system;
means to, upon determining that the remote system is automated, signal the remote system with indicia of the local system being automated; and
means to perform the data exchange comprising non-speech audio tones.
